(19) United States
(12) Patent Application Publication
(10) Pub. No.: US 2016/0206983 A1
(43) Pub. Date: Jul. 21, 2016

(54) FILTER ELEMENT

(71) Applicant: CLEAR EDGE-GERMANY GMBH, Geldern-Walbeck (DE)

(72) Inventor: Dominic Baron, Bolton Lancashire (GB)

(73) Assignee: Clear Edge-Germany GMBH, Geldern-Walbeck (DE)

(21) Appl. No.: 14/915,200

(22) PCT Filed: Aug. 29, 2014
(86) PCT No.: PCT/EP2014/068413

§ 371 Date: Feb. 26, 2016

(30) Foreign Application Priority Data
Aug. 29, 2013 (GB) 1315363.0

(51) Int. Cl. B01D 39/08

(52) U.S. Cl. CPC B01D 39/083

(57) ABSTRACT

A filter element comprising two layers of weft (1) interlaced with warp (2). Additionally laid-in (3) yams are provided in-between the two weft layers. The laid-in yarns (3) are not interlaced with the weft.

The present invention relates to a filter element (such as a filter belt), a horizontal chamber filtration apparatus (such as a tower press) comprising a filter element, and use of a filter element in a horizontal chamber filtration apparatus (such as a tower press).

Filter elements typically comprise woven fabric, that is a fabric comprising warp and weft yarns, wherein the weft is threaded through the warp. Warp yarns are typically longitudinal (i.e. run in the machine direction) and weft yarns are typically transverse (i.e. run perpendicular to the machine direction; the cross-machine direction). Since woven structures possess an inherent degree of stretch, such filter elements are susceptible to elongation when used on large filtration machines where the elements are placed under tension. This is particularly true in vertical tower presses, since a filter element in the form of a filter belt zig-zags down the machine and may be up to around 200 m long. This can mean significant elongation and a ‘stretch’ of several metres in total. As the filter element elongates it is exposed to greater loads, and so elongation is an ever increasing problem. This can lead to premature failure of the belt, possible damage to the filtration apparatus, and/or poor tracking of the belt leading to edge damage. Consequently it is desirable to reduce the susceptibility of filter elements to elongation, and/or to increase their modulus. In addition, filter elements are susceptible to abrasion, for example due to the presence of abrasive particles in the filtrate and/or from the filtration apparatus itself. Such abrasion reduces the working life of the filter element. It is therefore desirable to additionally improve the abrasion resistance of filter elements in order to prolong their working life.

According to a first embodiment of the present invention, there is provided a filter element comprising weft, warp and laid-in yarns, wherein the laid-in yarns do not interlace with the weft yarns and run substantially parallel to the warp yarns, the weft yarns run substantially perpendicular to the warp yarns, and wherein the ratio of the laid-in yarns to warp yarns is at least 1:4 and the weft yarns comprise an abrasion resistant material, preferably polyamide, e.g. NYLON.

According to a second embodiment of the present invention, there is provided a horizontal chamber filtration apparatus, such as a tower press, comprising a filter element according to the first embodiment.

According to a third embodiment of the present invention, there is provided the use of a filter element according to the first embodiment in a horizontal chamber filtration apparatus such as a tower press.

The laid-in yarns of the present invention give rise to filter elements having an increased modulus, i.e. a reduced tendency to elongation. Without wishing to be bound by theory, it is believed that the laid-in yarns reduce elongation as they do not interlace with any weft yarns, so that any elongation effects due to fabric crimp are reduced. Using laid in yarns in the warp direction, low load elongation values of 0.5% or less @400 N/5 cm are achievable according to DIN EN ISO (13934) without adversely affecting filtration performance. Further, the weft yarns comprising an abrasion resistant material, such as NYLON, give rise to filter elements having improved abrasion resistance. Orienting the filter element such that the laid-in yarns run vertically, parallel with the surface of a filter plate when in use, maximises the resistance to elongation.

Filter elements typically have top and bottom surfaces, wherein one or both of these surfaces can be used for filtration. When the filter element has weft yarns comprising polyamide, e.g. NYLON, as the predominant yarns on both the top and bottom surfaces of the filter element, it has particularly improved abrasion resistance, and when the filter element has a sateen weave, e.g. a weave of double faced construction comprising polyamide yarns on both surfaces, abrasion resistance is particularly improved.

The filter element ideally comprises at least two layers of weft and in one embodiment comprises only two layers of weft. The weft yarns comprising polyamide can comprise at least 80% wt at polyamide, e.g. NYLON, preferably 100% wt. The laid-in yarns do not interlace with any weft yarns.

The ratio of laid-in yarns to warp yarns is at least 1:4, and in various embodiments preferably at least 1:3, more preferably at least 1:2, most preferably at least 1:1, but it can also be 2:3. The laid-in yarns might in one embodiment comprise any one of polypropylene (PP), polyester (PET), polyethylene (PE), polybutylene terephthalate (PBT), polyphenylene sulfide (PPS) and/or aramid such as KEVLAR materials. In one embodiment their linear density is from 150 to 4400 dtex (grams/10,000 m), and in another embodiment from 1100 to 2200 dtex. The laid-in yarns can be multifilament staple or mono filament.

The warp yarns might in one embodiment comprise any of PP, PET, PE, PBT, PPS or Kevlar material. In one embodiment their linear density is from 150 to 4400 dtex. In another embodiment this is from preferably 1100 to 2200 dtex. The warp yarns can be multifilament staple or monofilament, and/or the warp yarns can be woven in any of plain weave, all twill combinations, or all satin combinations.

The weft yarns typically comprise abrasion resistant material such as NYLON (PA), and may also typically comprise PP, PET, PE, PBT, PPS or aramid (e.g. KEVLAR) material. In one embodiment the weft yarns consist essentially of, or consist of, NYLON (PA). In one embodiment their linear density is from 150 to 4400 dtex. In another embodiment this is from 1100 to 2200 dtex. The weft yarns can be multifilament staple or monofilament.

An abrasion resistant coating, for example of glue or resin, may optionally be applied to the filter element to increase lifetime. This coating may be (but is not limited to), for example, a two part epoxy or similar. Typically, the coating is an aqueous Phenol Formaldehyde resole system. The coating can also be impregnated into the fabric of the filter element.

The coating can be typically applied using a coating machine comprising a simple Knife over Air system, with a ‘J’ blade, which causes the resin to be forced into the filter element, thus giving an impregnation, rather than a discrete coating on top of the filter element. The coating should not, however, markedly alter the permeability of the filter element.

Usually the filter element is first coated and dried, and then cured preferably by passing down a stenter. Afterwards, hot calandering, at for example 145° C., is preferred.

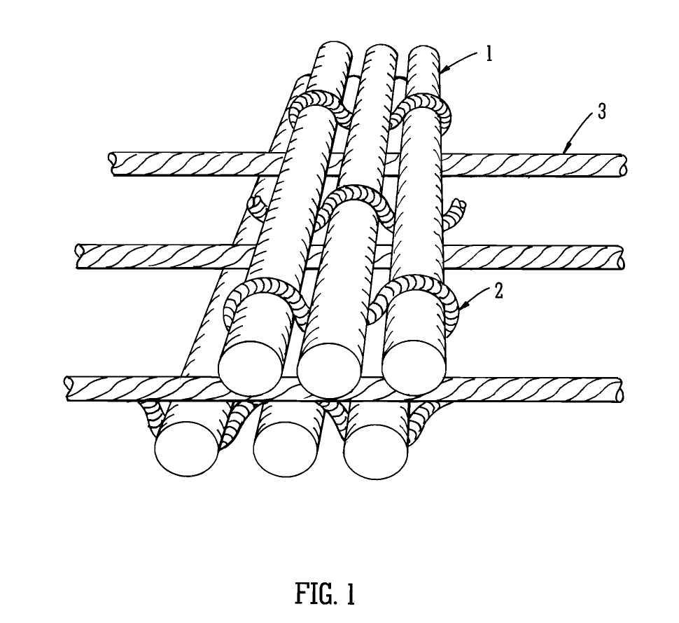

The present invention will now be illustrated, by way of example only, by reference to FIG. 1 which shows a schematic diagram of a filter element according to the invention.

In FIG. 1, two layers of weft yarns 1 and warp yarns 2 are interlaced to create a fabric, wherein the weft yarns run perpendicular to the machine direction and the warp yarns run parallel to it. Laid-in yarns 3 placed in-between the two weft layers also run parallel to the machine direction. There is a laid-in yarn present between each pair of warp yarns, such that the ratio of laid-in yarns to warp yarns is 1:1. The weft yarns 1 comprise an abrasion resistant material such as NYLON.

A filter element according to the invention, labeled V6 in the below tables, has been tested for abrasion resistance and extension resistance against standard Clear Edge and competitor (Tamfelt) materials.

The abrasion resistance was tested using a NuMartindale Abrasion Tester with single line test mode with a pressure of 12 kPa with 50 cycles per minute. The sandpaper used was Klingspor PSIIC (240 grain), and circular test samples of 140 mm in diameter were used. Samples were loaded in such a way that the cake side was in contact with the sandpaper. The results achieved were as follows in Table 1:

TABLE 1

| | After | After | After | After | After | After | After | After | After | After | After | After |
|---|---|---|---|---|---|---|---|---|---|---|---|---|
| Clear Edge | 100 | 500 | 2000 | 5000 | 8000 | 11000 | 13000 | 17000 | 19000 | 24000 | 30000 | 35000 |
| product ref | cycles | cycles | cycles | cycles | cycles | cycles | cycles | cycles | cycles | cycles | cycles | cycles |
| 98430F | Fine | Hairy | Hairy | Hairy | Hairy | Fine | Fabric | — | — | — | — | — |
| | dust | surface | surface | surface | surface | dust | failed | | | | | |
| | | | | and | and fine | and | | | | | | |
| | | | | warp | dust | hairy | | | | | | |
| | | | | flattens | | surface | | | | | | |
| | | | | up. | | | | | | | | |
| | | | | Fine | | | | | | | | |
| | | | | dust | | | | | | | | |
| 25330B | Fine | Hairy | Hairy | Hairy | Wefts | Pin | Fabric | — | — | — | — | — |
| | dust | surface | surface | surface | exposed. | holes in | failed | | | | | |
| | and | | | | Failure | one | | | | | | |
| | hairy | | | | appear | row. | | | | | | |
| | surface | | | | | Fabric | | | | | | |
| | | | | | | fails | | | | | | |
| 98320K | Fine | Hairy | Hairy | Hairy | Hairy | Hairy | Hairy | Fabric | — | — | — | — |
| | dust | surface | surface | surface | surface | surface | surface | failed. | | | | |
| | and | | | | | | | Warp | | | | |
| | hairy | | | | | | | completely | | | | |
| | surface | | | | | | | abrades off | | | | |
| 97770F | Fine | Hairy | Hairy | Hairy | Hairy | Fine | Hairy | Fabric | — | — | — | — |
| | dust | surface | surface | surface | surface | dust | surface | failed | | | | |
| | and | | | | and warp | and | | | | | | |
| | hairy | | | | flattens | hairy | | | | | | |
| | surface | | | | up. | surface | | | | | | |
| | | | | | Fine dust | | | | | | | |
| V6 (fabric | Fine | Fine | Fine | Fine | Fine dust | Fine | Fine | Fine dust | Hairy | Fine | Fine | Fabric |
| of the | dust | dust | dust | dust | and hairy | dust | dust | and hairy | surface | dust | dust | failed |
| invention) | and | and | and | and | surface | and | and | surface | and | and | and | |
| | hairy | hairy | hairy | hairy | | hairy | hairy | | weft | hairy | hairy | |
| | surface | surface | surface | surface | | surface | surface | | appears | surface | surface | |
| | | | | | | | | | on the | | | |
| | | | | | | | | | surface | | | |

As can be seen, the V6 (which is the product according to the invention) shows the highest abrasion resistance as compared to the other standard Clear Edge Fabrics.

The extension resistance of the V6 product was tested as compared to competitor's products (by Tamfelt) and as compared to other Clear Edge products. Testing was done by measuring (i) how much load must be attached per tensile metre in the warp direction to achieve 2% elongation, and (ii) the % elongation in the warp direction at a load of 400 N. As can be seen from table 2, the V6 (product according to the invention) has most favourable load characteristics.

TABLE 2

| | (i) Low Load | (ii) Low Load |
|---|---|---|
| Reference | N/5 cm @ 2% | % @ 400 N |
| Tamfelt | 600 | 1.6 |
| S 2206-L1 K4 | | |
| Tamfelt | 1000 | 1.1 |
| S 2106-L1 | | |
| Tamfelt | 1000 | 1.1 |
| S 2102-L1 K4 | | |
| Tamfelt | 1000 | 1.1 |
| S 2104-L1 | | |
| Tamfelt | 1200 | 1.0 |
| S 2123-L1 | | |
| Tamfelt | 850 | 1.3 |
| S 2110-L1 | | |
| Tamfelt | 900 | 1.0 |
| S 2209-L1 | | |
| Clear Edge | 1600 | 0.7 |
| 98320F | | |
| Clear Edge | 1400 | 0.7 |
| 97630F | | |
| Clear Edge | 900 | 1.2 |
| 97770F | | |
| Clear Edge | 1200 | 0.9 |
| 18830F | | |
| Clear Edge | 1600 | 0.7 |
| 98320F | | |
| Clear Edge | 1900 | 0.45 |
| V6 | | |

It is to be understood that the above described embodiment is by way of illustration only. Many modifications and variations are possible. For example three or more layers of weft may be provided in the filter.

1. A filter element comprising weft, warp and laid-in yarns, wherein:
the laid-in yarns do not interlace with the weft yarns and run substantially parallel to the warp yarns;
the weft yarns run substantially perpendicular to the warp yarns, and wherein;
the ratio of the laid-in yarns to warp yarns is at least 1:4 and the weft yarns comprise an abrasion resistant material.

2. A filter element according to claim 1, wherein the abrasion resistant material comprises polyamide.

3. A filter element according to claim 1, wherein the weft yarns are the predominant yarn on both the top and bottom surfaces of the filter element.

4. A filter element according to claim 1, wherein the weft yarns are woven in a double-faced sateen construction.

5. A filter element according to claim 1, wherein the ratio of laid-in yarns to warp yarns is approximately 1:1.

6. A filter element according to claim 1, wherein the filter element comprises two layers of weft yarns.

7. A filter element according to claim 1, wherein the laid-in, warp and/or weft yarns comprise any of the following either alone or in combination: PP, PET, PE, PBT, PPS and/or aramid materials.

8. A filter element according to claim 1, wherein the weft yarns consists essentially of polyamide.

9. A filter element according to claim 1, wherein the filter element is a filter belt.

10. A filter element according to claim 1, wherein the filter element additionally comprises an abrasion resistant coating.

11. A horizontal chamber filtration apparatus, such as a tower press, comprising a filter element according to claim 1.

12. Use of a filter element according to claim 1 in a horizontal chamber filtration apparatus such as a tower press.
